(19) United States
(12) Patent Application Publication
(10) Pub. No.: US 2020/0310439 A1
(43) Pub. Date: Oct. 1, 2020

(54) TRAVELING ROUTE GENERATION DEVICE AND VEHICLE CONTROL DEVICE

(71) Applicant: AISIN SEIKI KABUSHIKI KAISHA, Kariya-shi (JP)

(72) Inventors: Hiroyuki KATO, Kariya-shi (JP); Yosuke HASHIMOTO, Kariya-shi (JP)

(73) Assignee: AISIN SEIKI KABUSHIKI KAISHA, Kariya-shi (JP)

(21) Appl. No.: 16/817,721

(22) Filed: Mar. 13, 2020

(30) Foreign Application Priority Data
Mar. 28, 2019 (JP) 2019-062555

(51) Int. Cl. G05D 1/02; G01C 21/34; G06K 9/00

(52) U.S. Cl. CPC G05D 1/0212; G01C 21/3492; G05D 2201/0212; G05D 2201/0213; G06K 9/00798

(57) ABSTRACT

A traveling route generation device includes a lane shape detection unit detecting a shape of a traveling lane in which a host vehicle is traveling, a lateral position detection unit detecting a lateral position that is a position of the host vehicle in a width direction of the traveling lane, and a traveling route generation unit generating, as a traveling route of the host vehicle when traveling in a curved section, a route in which an offset distance of the host vehicle remains at an entry offset distance on the basis of detection results of the lane shape detection unit and the lateral position detection unit. The offset distance indicates a distance between a lane center line and the lateral position of the host vehicle, and the entry offset distance indicates the offset distance of the host vehicle when entering the curved section.

### CROSS REFERENCE TO RELATED APPLICATIONS

This application is based on and claims priority under 35 U.S.C. § 119 to Japanese Patent Application 2019-062555, filed on Mar. 28, 2019, the entire contents of which are incorporated herein by reference.

### TECHNICAL FIELD

This disclosure relates to a traveling route generation device and a vehicle control device including the traveling route generation device.

### BACKGROUND DISCUSSION

In the related art, a device described in JP 2014-139063A (Reference 1) has been known as a vehicle control device which performs automatic traveling so as to cause a host vehicle to travel along a traveling lane. The vehicle control device described in Reference 1 detects the shape of a traveling lane and a lateral position that is the position of a host vehicle in the width direction of the traveling lane. Then, the vehicle control device calculates, as a basic steering control amount, a steering control amount for causing the host vehicle to travel along a basic traveling route that is a traveling route following the shape of the traveling lane. Further, the vehicle control device calculates, as a correction steering control amount, a steering control amount for causing the host vehicle to travel along a correction route that is a virtual traveling route for correcting a deviation of the lateral position of the host vehicle from the basic traveling route, i.e., an offset of the host vehicle in the width direction of the traveling lane. Then, the vehicle control device determines an instruction steering control amount that is the instruction value of a steering control amount based on the basic steering control amount and the correction steering control amount to perform the steering control of the vehicle, thereby realizing the automatic traveling of the vehicle along the traveling lane.

The above-described conventional vehicle control device performs the automatic traveling while correcting the deviation of the lateral position of the host vehicle in the traveling lane so as to prevent the host vehicle from departing from the traveling lane. Here, a case where an operation of correcting the deviation of the lateral position during traveling in a curved section of the traveling lane is performed is considered.

FIG. 11 illustrates a traveling route of a host vehicle C by the two-dot chain line in a case where an operation of correcting a lateral position deviation to the outside of the curve is performed during traveling in a curved section. A lane center line illustrated by the one-dot chain line in FIG. 11 and FIG. 12 to be described later is a line that passes through the center in the width direction of a traveling lane. In this process of correcting the lateral position deviation, the turning radius of the host vehicle C temporarily becomes smaller than the radius of curvature R of the curve. For this reason, there is a possibility of an occupant predicting, from the turning radius of the host vehicle C at that time, a route having an oversteer tendency as illustrated by the dotted arrow in FIG. 11 as a subsequent traveling route of the host vehicle C.

FIG. 12 illustrates a traveling route of the host vehicle C by the two-dot chain line in a case where an operation of correcting a lateral position deviation to the inside of the curve is performed during traveling in a curved section. In this process of correcting the lateral position deviation, the turning radius of the host vehicle C temporarily becomes larger than the radius of curvature R of the curve. For this reason, there is a possibility of an occupant predicting, from the turning radius of the host vehicle C at that time, a route having an understeer tendency as illustrated by the dotted arrow in FIG. 12 as a subsequent traveling route of the host vehicle C.

As described above, when an operation of correcting a lateral position deviation is performed during traveling in a curved section by automatic traveling, the turning behavior of a vehicle may be different from an expected behavior, which may cause an occupant to feel a sense of discomfort.

### SUMMARY

A traveling route generation device according to an aspect of this disclosure includes a lane shape detection unit configured to detect a shape of a traveling lane in which a host vehicle is traveling, a lateral position detection unit configured to detect a lateral position that is a position of the host vehicle in a width direction of the traveling lane, and a traveling route generation unit configured to generate, as a traveling route of the host vehicle when traveling in a curved section, a route in which an offset distance of the host vehicle remains at an entry offset distance on the basis of detection results of the lane shape detection unit and the lateral position detection unit. Here, the offset distance indicates a distance between a lane center line that is a line passing through a center in the width direction of the traveling lane and the lateral position of the host vehicle. Further, the entry offset distance indicates the offset distance of the host vehicle when entering the curved section of the traveling lane.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating a configuration of a first embodiment of a traveling route generation device and a vehicle control device;

FIG. 2 is a diagram illustrating a situation before a vehicle enters a curved section;

FIG. 3 is a flowchart of a curve traveling routine executed by the vehicle control device of the first embodiment during traveling in a curved section;

FIG. 4 is a graph illustrating a relationship between an instruction speed and an entry offset distance which are set in the curve traveling routine;

FIG. 5 is a diagram illustrating a setting mode of a traveling route when entering a curved section in a state with a lateral position deviated to the outside of the curve;

FIG. 6 is a diagram illustrating a setting mode of a traveling route when entering a curved section with a lateral position deviated to the inside of the curve;

FIG. 7 is a flowchart of a straight traveling routine executed by a traveling route generation unit in a vehicle control device of a second embodiment;

FIG. 8 is a graph illustrating a relationship between a correction prohibition distance and a traveling speed which are set in the straight traveling routine;

FIG. 9 is a diagram illustrating the behavior of a vehicle when an operation of correcting a lateral position deviation to the outside of the curve is performed immediately before entering a curved section;

FIG. 10 is a diagram illustrating the behavior of a vehicle when an operation of correcting a lateral position deviation to the inside of the curve is performed immediately before entering a curved section;

FIG. 11 is a diagram illustrating a traveling route of a vehicle when a turning operation of correcting a lateral position deviation to the outside of the curve is performed during traveling in a curved section; and

FIG. 12 is a diagram illustrating a traveling route of a vehicle when a turning operation of correcting a lateral position deviation to the inside of the curve is performed during traveling in a curved section.

### DETAILED DESCRIPTION

### First Embodiment

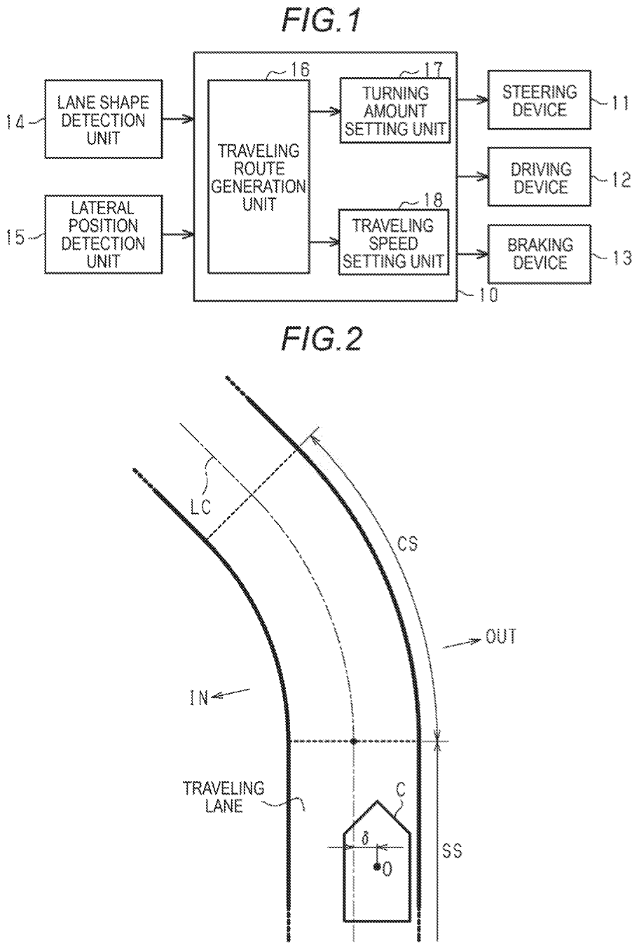

Hereinafter, a first embodiment of a traveling route generation device and a vehicle control device will be described in detail with reference to FIGS. 1 to 6.

A vehicle control device 10 according to the present embodiment illustrated in FIG. 1 is configured as an electronic control device that performs the automatic traveling of a vehicle via the control of a steering device 11 which changes the steering angle of steered wheels of the vehicle, a driving device 12 which generates a driving force of the vehicle, and a braking device 13 which generates a braking force of the vehicle. The steering device 11 includes an actuator for adjusting the steering angle of the steered wheels and a control unit which controls the actuator. The driving device 12 includes a power source such as an engine or a motor, a transmission which changes the ratio of rotation speeds between an output shaft of the power source and a driving wheel and a control unit which controls the power source and the transmission. The braking device 13 includes a brake provided on each wheel of the vehicle and a control unit which controls the brake. In the following description, a vehicle on which the vehicle control device 10 is mounted is referred to as a host vehicle C.

Detection results of a lane shape detection unit 14 which detects the shape of a traveling lane in which the host vehicle C is traveling and a lateral position detection unit 15 which detects a lateral position that is the position of the host vehicle C in the width direction of the traveling lane are input respectively to the vehicle control device 10. In the present embodiment, the lane shape detection unit 14 adopts detecting the shape of the traveling lane by recognizing the left and right boundaries of the traveling lane by analysis of imaging data of an image sensor which captures an image of the heading direction of the host vehicle C. Further, in the present embodiment, the lateral position detection unit 15 adopts detecting the lateral position of the host vehicle C in the traveling lane from a positional relationship between the left and right boundaries of the traveling lane recognized by analysis of the imaging data of the image sensor.

Further, the vehicle control device 10 includes a traveling route generation unit 16 which generates a traveling route on which the host vehicle C subsequently travels on the basis of the detection results of the lane shape detection unit 14 and the lateral position detection unit 15. Furthermore, the vehicle control device 10 includes a turning amount setting unit 17 which sets an instruction steering amount that is the instruction value of a steering amount for causing the host vehicle C to travel along the traveling route generated by the traveling route generation unit 16 and a traveling speed setting unit 18 which sets an instruction speed that is the instruction value of a traveling speed when the host vehicle C travels along the traveling route. The traveling route generation unit 16 performs the generation of the traveling route at each predetermined control cycle. That is, the traveling route generated by the traveling route generation unit 16 is updated at each predetermined control cycle according to the detection result of the shape of the traveling lane and the lateral position at that time. The lane shape detection unit 14, the lateral position detection unit 15, and the traveling route generation unit 16 in the vehicle control device 10 constitute a traveling route generation device which generates a traveling route for automatically traveling of the host vehicle along the traveling lane.

Then, the vehicle control device 10 controls the steering device 11 according to the instruction steering amount set by the turning amount setting unit 17. In addition, in the present embodiment, the yaw rate is used as an index value of the steering amount. That is, the turning amount setting unit 17 in the present embodiment sets, as the value of the instruction steering amount, the yaw rate necessary to cause the host vehicle C to travel along the traveling route generated by the traveling route generation unit 16. Then, the steering device 11 in the present embodiment changes the steering angle of the steered wheels so that the yaw rate instructed as the value of the indication steering amount is obtained.

Furthermore, the vehicle control device 10 controls the driving device 12 and the braking device 13 according to the instruction speed set by the traveling speed setting unit 18. Specifically, the vehicle control device 10 sets, as the values of an instruction driving force and an instruction braking force, the driving force and the braking force necessary to make the traveling speed of the host vehicle C equal to the instruction speed. Then, the driving device 12 adjusts the driving force of the host vehicle C so as to have the same magnitude as the instruction driving force, and the braking device 13 adjusts the braking force of the host vehicle C so as to have the same magnitude as the instruction braking force, so that the traveling speed of the host vehicle C is controlled so as to be equal to the instruction speed.

Next, each term used in the following description will be described with reference to FIG. 2. In the following description, a section which is present in a traveling lane and in which the traveling lane is curved is referred to as a curved section CS. Further, a section which is present in a traveling lane and in which the traveling lane immediately before the curved section CS extends straight is referred to as a pre-curve straight section SS. Furthermore, with respect to the traveling lane, the side indicated by the arrow IN in the width direction of the traveling lane, i.e., the side where the center of curvature of the curved section CS is located is referred to as the inside of the curve, and the opposite side indicated by the arrow OUT is referred to as the outside of the curve.

Furthermore, in the following description, a line passing through the center in the width direction of the traveling lane is referred to as a lane center line LC. Then, the distance between the center of gravity O of the host vehicle C and the lane center line LC is referred to as an offset distance δ. In the following description, the offset distance δ is represented as a value that takes a positive value when the center of gravity O of the host vehicle C is located at the outside of the curve than the lane center line LC and that takes a negative value when the center of gravity O of the host vehicle C is located at the inside of the curve than the lane center line LC. That is, the offset distance δ is represented as a value that takes zero when the center of gravity O of the host vehicle C is located on the lane center line LC and that gradually decreases when the lateral position that is the position of the host vehicle C in the width direction of the traveling lane changes from the outside of the curve to the inside of the curve.

By the way, the traveling route generation unit 16 in the vehicle control device 10 of the present embodiment generates, as the traveling route, a route on which the host vehicle C travels along the lane center line LC when automatically traveling in a straight section of the traveling lane, i.e., a section in which the traveling lane straightly extends. Specifically, when the center of gravity O of the host vehicle C deviates from the lane center line LC, i.e., when the offset distance δ is not zero, the traveling route generation unit 16 generates, as the traveling route when traveling in the straight section, a route in which the offset distance δ gradually approaches zero. Further, when the center of gravity O of the host vehicle C is located on the lane center line LC, i.e., when the offset distance δ is zero, the traveling route generation unit 16 generates, as the traveling route when traveling in the straight section, a route along the lane center line LC, i.e., a route in which the offset distance δ remains at zero. Thus, the vehicle control device 10 causes the host vehicle C to automatically travel along the traveling lane while performing a turning operation to correct a deviation of the lateral position of the host vehicle C when the deviation occurs during traveling in the straight section of the traveling lane.

The traveling speed setting unit 18 in the vehicle control device 10 sets, as the value of the instruction speed when traveling in the straight section, a set speed which is set in advance. As the value of the set speed, a speed set as the traveling speed of the host vehicle C during automatic traveling by a driver, or a legal speed in the currently-traveling traveling lane acquired from a car navigation system or the like is set.

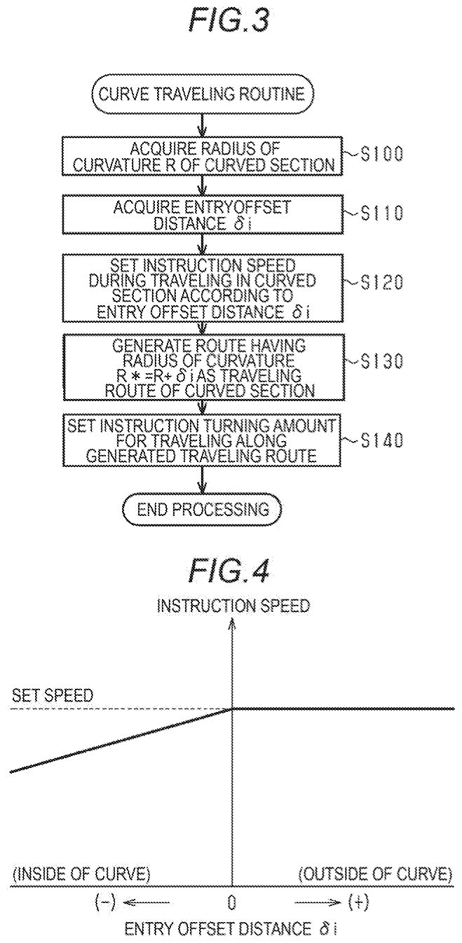

Meanwhile, when traveling in the curved section CS, the traveling route generation unit 16 performs the automatic traveling of the host vehicle C via a processing of a curve traveling routine illustrated in FIG. 3. While traveling in the curved section CS, the vehicle control device 10 repeatedly executes the processing of the curve traveling routine at each predetermined control cycle.

When the processing of this routine is initiated, first in step S100, the vehicle control device 10 acquires the radius of curvature R of the currently-traveling curved section CS from the detection result of the lane shape detection unit 14. Here, the radius of curvature R of the curved section CS represents the radius of curvature of the lane center line LC in the curved section CS.

Further, in the following step S110, the vehicle control device 10 acquires an entry offset distance δi that is the offset distance δ of the host vehicle C when entering the curved section CS. More specifically, when initially executing this routine after entering the curved section CS, the vehicle control device 10 executes, as a processing of step S110, the processing of obtaining the entry offset distance δi from the detection result of the lateral position detection unit 15 and storing the value of the entry offset distance δi. Further, when executing this routine from the second time onwards after entering the curved section CS, the vehicle control device 10 executes, as the processing of step S110, a processing of reading the stored value of the entry offset distance δi.

Subsequently, in step S120, the vehicle control device 10 sets the instruction speed during traveling in the curved section CS according to the entry offset distance δi. The instruction speed at this time is set to be lower when the entry offset distance δi is small than that when the entry offset distance δi is large.

FIG. 4 illustrates a relationship between the entry offset distance δi and a set value of the instruction speed in the present embodiment. In the present embodiment, when the entry offset distance δi is zero or a positive value, i.e., when the center of gravity O of the host vehicle C at the time of entering the curved section CS is located on the lane center line LC or at the outside of the curve than the lane center line LC, the above-mentioned set speed which is set in advance is set as the value of the instructed speed. Meanwhile, when the entry offset distance δi is a negative value, i.e., when the center of gravity O of the host vehicle C at the time of entering the curved section CS is located at the inside of the curve than the lane center line LC, a speed lower than the set speed is set as the value of the instruction speed. Specifically, when the entry offset distance δi gradually decreases from zero, the value of the instruction speed is set as a value that gradually decreases from the set speed which is a value when the entry offset distance δi is zero as the entry offset distance δi decreases.

After setting the instruction speed, in step S130, the vehicle control device 10 generates, as the traveling route when traveling in the curved section CS, a route having the radius of curvature R* obtained by correcting the radius of curvature R of the curved section CS according to the entry offset distance δi. More specifically, the vehicle control device 10 generates, as the traveling route when traveling in the curved section CS, a constant curvature route having a radius of curvature R* as the sum (=R+δi) obtained by adding the entry offset distance δi to the radius of curvature R of the curved section CS. Then, in the following step S140, the vehicle control device 10 sets, as the value of the instruction turning amount, a turning amount for causing the host vehicle C to travel along the generated traveling route, and then ends the processing of this routine this time.

The processing of step S120 of the above-described curve traveling routine in the vehicle control device 10 is a processing performed by the traveling speed setting unit 18. Further, the processing of step S130 of the curve traveling routine in the vehicle control device 10 is a processing performed by the traveling route generation unit 16 and is a processing corresponding to a generation processing. Furthermore, the processing of step S140 of the curve traveling routine in the vehicle control device 10 is a processing performed by the turning amount setting unit 17.

Actions and effects of the present embodiment will be described.

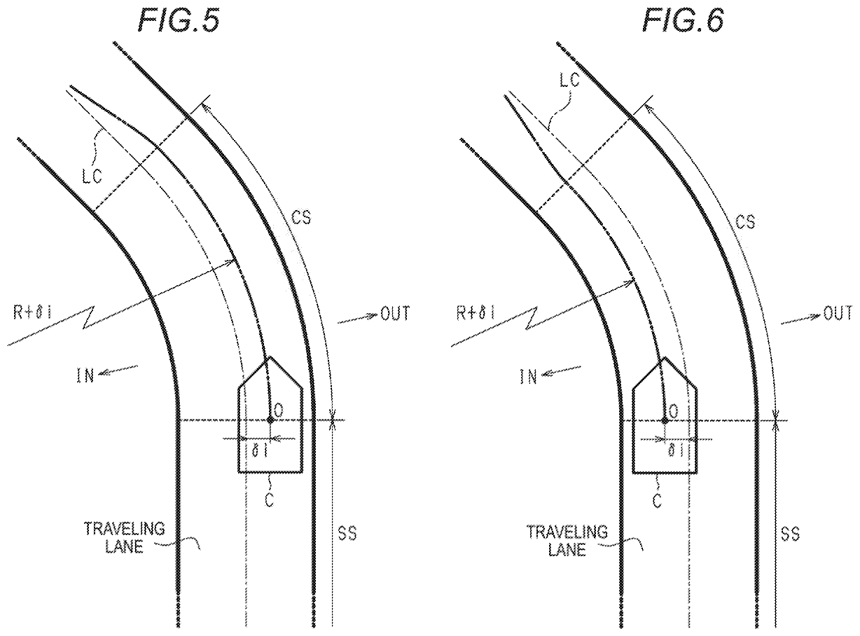

FIGS. 5 and 6 illustrate a setting mode of the traveling route when traveling in the curved section CS according to the present embodiment. FIG. 5 illustrates a setting mode of the traveling route when the host vehicle C enters the curved section CS with the lateral position deviated to the outside of the curve, and FIG. 6 illustrates a setting mode of the traveling route when the host vehicle C enters the curved section CS with the lateral position deviated to the inside of the curve.

As described above, in the curve traveling routine, the route in which the sum of the radius of curvature R of the curved section CS and the offset distance δ is the radius of curvature R* is set as the traveling route during traveling in the curved section CS. This traveling route is a route in which the offset distance δ of the host vehicle C remains at the entry offset distance δi. That is, in the present embodiment, an operation of correcting a lateral position deviation of the host vehicle C is not performed during traveling in the curved section CS. The traveling route of the host vehicle C in the curved section CS in this case is a route parallel to the lane center line LC, i.e., a route that follows the curved shape of the traveling lane. Therefore, a route close to the route predicted by the occupant based on the shape of the curve is generated as the traveling route in the curved section CS. Accordingly, by causing the host vehicle C to travel along the traveling route generated in this way, the automatic traveling in the curved section CS of the traveling lane may be realized such that the occupant does not easily feel a sense of discomfort.

In the present embodiment, the turning radius of the host vehicle C when traveling in the curved section CS changes according to the entry offset distance δi. When the traveling speed during a turning operation is the same, the smaller the turning radius, the larger the lateral G applied to a vehicle body and the lower the occupants comfort. Meanwhile, the traveling speed setting unit 18 in the vehicle control device 10 of the present embodiment sets the instruction traveling speed during traveling in the curved section CS so as to be lower when the entry offset distance δi is small than that when the entry offset distance δi is large. That is, the traveling speed setting unit 18 sets the traveling speed of the host vehicle C to be lower when a route having a small radius of curvature is set as the traveling route of the curved section CS than that when a route having a large radius of curvature is set. Therefore, an increase in the lateral G and consequently deterioration in the occupant's comfort are suppressed when the turning radius of the host vehicle C decreases when traveling in the curved section CS.

Incidentally, also in the present embodiment, when it is predicted that the vehicle departs from the traveling lane, approaches a preceding vehicle, or collides with an obstacle, for example, the traveling route generation unit 16 performs the generation of the traveling route to avoid these problems with priority to the generation of the traveling route in the above-described mode.

### Second Embodiment

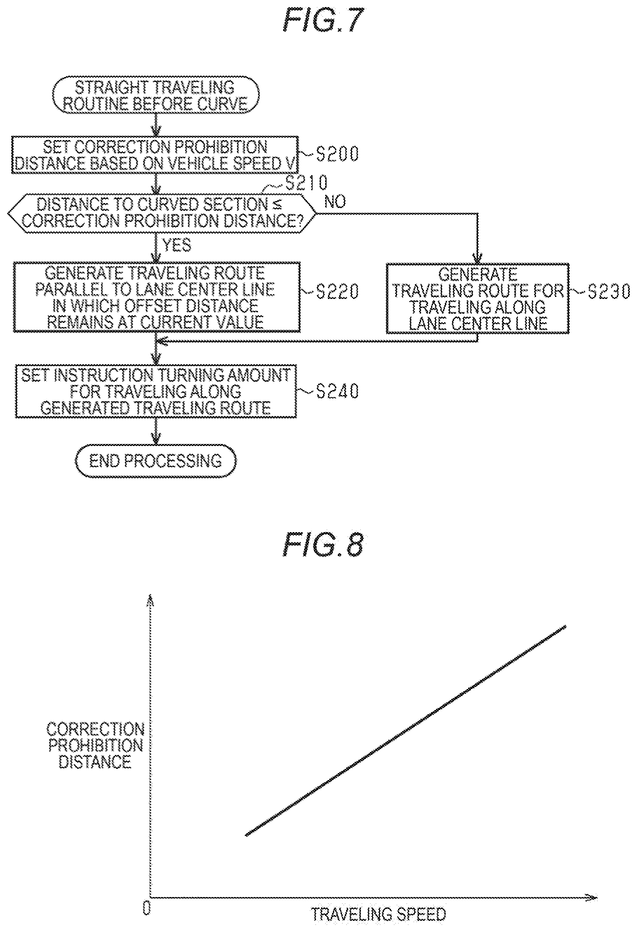

Next, a second embodiment of the traveling route generation device and the vehicle control device will be described with reference to FIGS. 7 to 10. In the present embodiment, the same components as those in the above embodiment will be denoted by the same reference numerals, and a detailed description thereof will be omitted. Since the configurations of the traveling route generation device and the vehicle control device 10 of the present embodiment are basically the same as those of the first embodiment illustrated in FIG. 1, also in the present embodiment, the vehicle control device 10 performs the automatic traveling when traveling in the curved section CS of the traveling lane via the processing of the curve traveling routine illustrated in FIG. 3. However, the vehicle control device 10 of the present embodiment is different from that of the first embodiment in that it performs the automatic traveling when traveling in the pre-curve straight section SS of the traveling lane via a processing of a straight traveling routine illustrated in FIG. 7. The vehicle control device 10 of the present embodiment repeatedly executes the processing of the straight traveling routine at each predetermined control cycle while traveling in the pre-curve straight section SS of the traveling lane.

When the processing of this routine is initiated, first in step S200, the vehicle control device 10 sets the value of a correction prohibition distance based on the current traveling speed of the host vehicle C. As illustrated in FIG. 8, a larger value is set as the value of the correction prohibition distance as the current traveling speed of the host vehicle C increases.

Subsequently, in step S210, the vehicle control device 10 determines whether or not the distance from the current position of the host vehicle C to the entry position of the curved section CS ahead of the pre-curve straight section SS is equal to or less than the correction inhibition distance. Then, when the distance to the entry position of the curved section CS is equal to or less than the correction prohibition distance (S210: YES), in step S220, the vehicle control device 10 generates, as the traveling route, a route parallel to the lane center line LC in which the offset distance δ remains at the current value. That is, at this time, even if a lateral position deviation of the host vehicle C occurs with respect to the traveling lane, a route on which the vehicle travels straight without correction of the deviation is generated as the traveling route. Meanwhile, when the distance to the entry position of the curved section CS is greater than the correction prohibition distance (S210: NO), in step S230, the vehicle control device 10 generates, as the traveling route, a route on which the vehicle travels along the lane center line LC. At this time, when a lateral position deviation of the host vehicle C occurs with respect to the traveling lane, the deviation of the lateral position is corrected, and after the correction, a route on which the vehicle travels straight along the lane center line LC is generated as the traveling route.

Thereafter, in step S240, the vehicle control device 10 sets, as the value of the instruction turning amount, a turning amount for traveling along the traveling route generated in step S220 or step S230, and then ends the processing of this routine this time. In the vehicle control device 10 of the present embodiment, the processing of step S220 or step S230 in the above-described pre-curve straight traveling routine is a processing performed, as a generation processing, by the traveling route generation unit 16 as the traveling route generation device. Further, the processing of step S240 in the above-described pre-curve straight traveling routine is a processing performed by the turning amount setting unit 17.

As described above, in the curve traveling routine, the traveling speed in the curved section CS is adjusted according to the entry offset distance δi. Meanwhile, when the traveling route of the pre-curve straight section SS is set as described above, the offset distance δ of the host vehicle C is fixed from the position before the correction prohibition distance from the entry position of the curved section CS, and at that time, the entry offset distance δi is determined. Therefore, in this case, the adjustment of the traveling speed to the instruction speed set according to the entry offset distance δi may be performed during traveling in the pre-curve straight section SS.

Actions and effects of the present embodiment will be described.

The vehicle control device 10 of the present embodiment generates, as the traveling route, a route parallel to the lane center line LC regardless of whether or not a lateral position deviation of the host vehicle C occurs with respect to the traveling lane when the distance to the entry position of the curved section CS becomes equal to or less than the correction prohibition distance during traveling in the pre-curve straight section SS. That is, a turning operation of correcting the deviation of the lateral position of the host vehicle C with respect to the traveling lane is not performed immediately before the curved section CS.

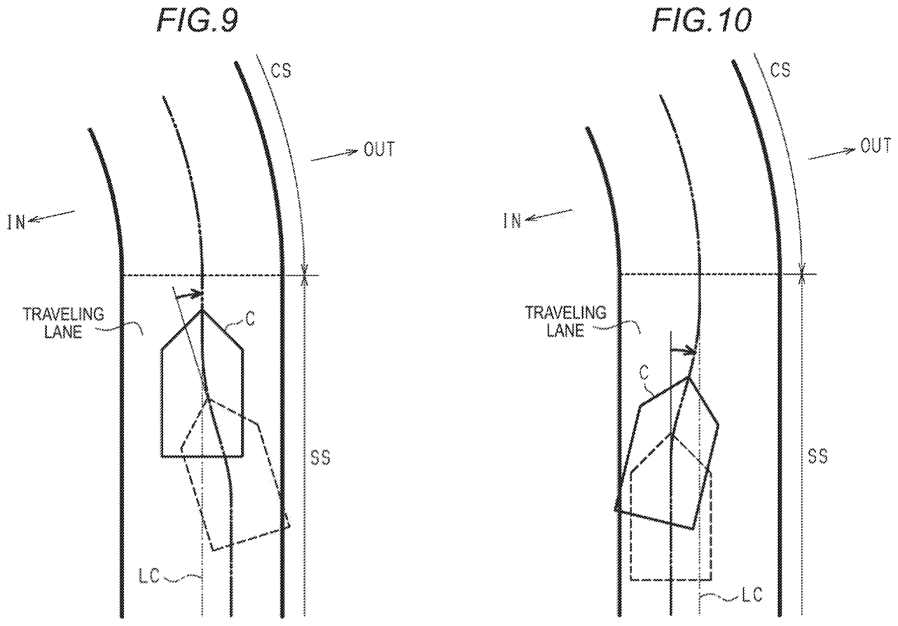

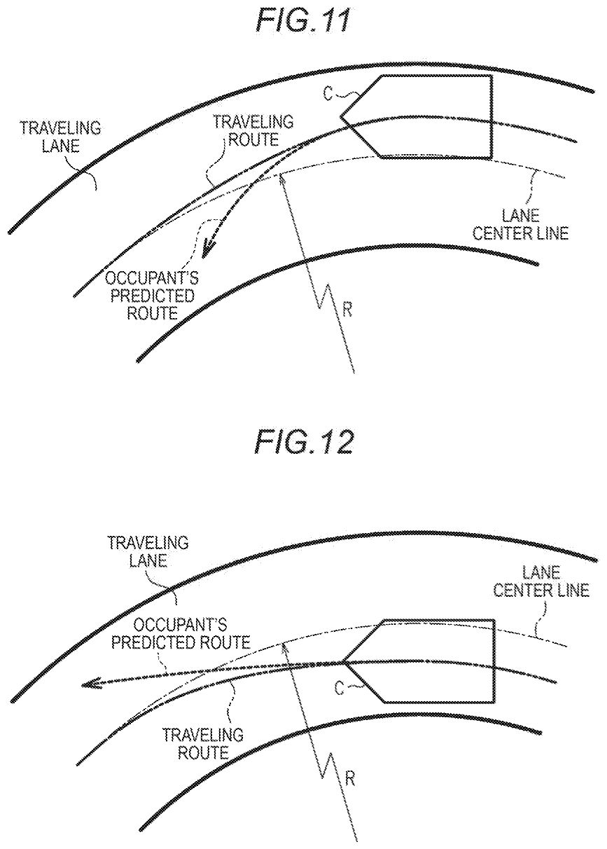

Meanwhile, FIG. 9 illustrates the traveling route of the host vehicle C when a turning operation of correcting a lateral position deviation to the outside of the curve is performed immediately before the host vehicle C enters the curved section CS. At this time, at the end of the turning operation of correcting the deviation of the lateral position of the host vehicle C, a turning operation of turning the host vehicle C toward the outside of the curve is performed in order to return the direction of the host vehicle C to the direction in which the traveling lane extends. The direction of the turning operation at this time is opposite to the curve direction of the curved section CS that the vehicle travels immediately afterward. Since the occupant at this time expects that a turning operation in the curve direction of the curved section CS that the vehicle travels immediately afterward is performed, the occupant may feel a sense of discomfort due to implementation of the turning operation in the opposite direction of the expected turning operation.

Further, FIG. 10 illustrates the traveling route of the host vehicle C when a turning operation of correcting a lateral position deviation to the inside of the curve is performed immediately before the host vehicle C enters the curved section CS. At this time, at the beginning of the turning operation of correcting the deviation of the lateral position of the host vehicle C, a turning operation of turning the host vehicle C toward the outside of the curve is performed in order to bring the host vehicle C to be close to the lane center line LC. Therefore, also in this case, since the turning operation in the direction opposite to the curve direction of the curved section CS is performed immediately before entering the curved section CS, this turning operation may cause the occupant to feel a sense of discomfort.

In this regard, in the present embodiment, when the distance from the current position of the host vehicle C to the entry position of the curved section CS becomes equal to or less than the correction prohibition distance during traveling in the pre-curve straight section SS, the turning operation for correcting the deviation of the lateral position is prohibited. Therefore, it is possible to avoid a situation in which the turning operation is performed in the direction opposite to the curve direction immediately before entering the curved section CS and the occupant feels a sense of discomfort.

Incidentally, even when the distance from the current position of the host vehicle C to the entry position of the curved section CS is the same, the host vehicle C reaches the entry position of the curved section CS within a shorter time when the traveling speed is high than when the traveling speed is low. Therefore, the position where the occupant is conscious of the transition from the pre-curve straight section SS to the curved section CS is located further ahead as the traveling speed is higher. In the present embodiment, in response to this, a longer distance is set as the value of the correction prohibition distance as the traveling speed is higher.

In the present embodiment, when it is predicted that the vehicle departs from the traveling lane, approaches a preceding vehicle, or collides with an obstacle, for example, the traveling route generation unit 16 performs the generation of the traveling route to avoid these problems with priority to the generation of the traveling route in the above-described mode.

The above embodiments may be modified and implemented as follows.
The detection of the shape of the traveling lane by the lane shape detection unit 14 or the detection of the lateral position of the host vehicle C in the traveling lane by the lateral position detection unit 15 may be performed in a mode different from the above-described mode. For example, the detection of the shape of the traveling lane may be performed by acquiring the shape of the traveling lane from a car navigation system.
The setting of the instruction speed depending on the entry offset distance δi in step S120 of the curve traveling routine may be performed in a mode different from the mode illustrated in FIG. 4 as long as a relationship in which the instruction speed when the entry offset distance δi is small is lower than the instruction speed when the entry offset distance δi is large is maintained.
When the set speed is low or when the radius of curvature R of the curved section CS is sufficiently large, a stable turning operation may be possible even if the turning radius of the host vehicle C when traveling in the curved section CS is reduced without departing from the traveling lane. When the automatic traveling is performed only in such a situation, the processing of step S120 of the curve traveling routine may be omitted.
The turning operation for causing the host vehicle C to automatically travel along the traveling route generated by the traveling route generation unit 16 may be performed by setting a difference in the driving force transmitted to the left and right driving wheels by the driving device 12 or by setting a difference in the braking force applied to each wheel by the braking device 13. Further, the turning operation may be performed by combining any two or more of the setting of the difference in the driving force, the setting of the difference in the braking force, and the adjustment of the steering angle of the steered wheels by the steering device 11.
In the above embodiments, the automatic traveling of the host vehicle C is performed by automatically controlling all of the steering amount, the driving force, and the braking force, but the automatic traveling may be performed by manually controlling at least one of the driving force and the braking force.

A traveling route generation device according to an aspect of this disclosure includes a lane shape detection unit configured to detect a shape of a traveling lane in which a host vehicle is traveling, a lateral position detection unit configured to detect a lateral position that is a position of the host vehicle in a width direction of the traveling lane, and a traveling route generation unit configured to generate, as a traveling route of the host vehicle when traveling in a curved section, a route in which an offset distance of the host vehicle remains at an entry offset distance on the basis of detection results of the lane shape detection unit and the lateral position detection unit. Here, the offset distance indicates a distance between a lane center line that is a line passing through a center in the width direction of the traveling lane and the lateral position of the host vehicle. Further, the entry offset distance indicates the offset distance of the host vehicle when entering the curved section of the traveling lane.

In the above-described traveling route generation device, when causing the vehicle to travel along the traveling route in the curved section generated by the traveling route generation unit, the vehicle travels along the shape of the curve since an operation of correcting a lateral position deviation of the vehicle is not performed during traveling in the curved section. Therefore, the traveling route when traveling in the curved section is close to a route that is predicted by an occupant from the shape of the curve. Accordingly, the traveling route generation device may realize automatic traveling in the curved section of the traveling lane such that the occupant does not easily feel a sense of discomfort.

In the traveling route generation device, the traveling route generation unit may set a value obtained by correcting a radius of curvature of the curved section according to the entry offset distance as a radius of curvature of the traveling route when traveling in the curved section.

In the traveling route generation device, the traveling route generation unit may generate a route parallel to the lane center line as the traveling route in a section between an entry position of the curved section in the traveling lane and a position before a predetermined distance from the entry position.

A vehicle control device according to another aspect of this disclosure is provided with the traveling route generation device and is configured to control a turning amount of a host vehicle so as to cause the host vehicle to travel along a traveling route generated by the traveling route generation device. The vehicle control device includes a traveling speed setting unit configured to set a traveling speed during traveling in the curved section so as to be lower when the entry offset distance is small than when the entry offset distance is large, the entry offset distance is represented as a value that takes a negative value when the lateral position of the host vehicle is located at an inside of a curve relative to the lane center line and that takes a positive value when the lateral position of the host vehicle is located at an outside of the curve relative to the lane center line.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A traveling route generation device comprising:
a lane shape detection unit configured to detect a shape of a traveling lane in which a host vehicle is traveling;
a lateral position detection unit configured to detect a lateral position that is a position of the host vehicle in a width direction of the traveling lane; and
a traveling route generation unit configured to generate, as a traveling route of the host vehicle when traveling in a curved section, a route in which an offset distance of the host vehicle remains at an entry offset distance on the basis of detection results of the lane shape detection unit and the lateral position detection unit, the offset distance indicating a distance between a lane center line that is a line passing through a center in the width direction of the traveling lane and the lateral position of the host vehicle, and the entry offset distance indicating the offset distance of the host vehicle when entering the curved section of the traveling lane.

2. The traveling route generation device according to claim 1, wherein
the traveling route generation unit sets a value obtained by correcting a radius of curvature of the curved section according to the entry offset distance as a radius of curvature of the traveling route when traveling in the curved section.

3. The traveling route generation device according to claim 1, wherein
the traveling route generation unit generates a route parallel to the lane center line as the traveling route in a section between an entry position of the curved section in the traveling lane and a position before a predetermined distance from the entry position.

4. A vehicle control device provided with the traveling route generation device according to claim 1 and configured to control a turning amount of a host vehicle so as to cause the host vehicle to travel along a traveling route generated by the traveling route generation device, the vehicle control device comprising:
a traveling speed setting unit configured to set a traveling speed during traveling in the curved section so as to be lower when the entry offset distance is small than when the entry offset distance is large, the entry offset distance is represented as a value that takes a negative value when the lateral position of the host vehicle is located at an inside of a curve relative to the lane center line and that takes a positive value when the lateral position of the host vehicle is located at an outside of the curve relative to the lane center line.
